(19) United States
(12) Patent Application Publication
(10) Pub. No.: US 2024/0246543 A1
(43) Pub. Date: Jul. 25, 2024

(54) DRIVER ATTENTIVENESS DETECTION METHOD AND DEVICE

(71) Applicant: Magna Electronics Sweden AB, Vågårda (SE)

(72) Inventor: OLA BOSTRÖM, GÖTEBORG (SE)

(21) Appl. No.: 18/624,751

(22) Filed: Apr. 2, 2024

Related U.S. Application Data
(63) Continuation of application No. 16/768,843, filed on Jun. 1, 2020, now abandoned.

(30) Foreign Application Priority Data
Dec. 1, 2017 (EP) 17204922.3

(51) Int. Cl. B60W 40/08; B60W 40/04; B60W 50/14; G06V 20/56; G06V 20/59

(52) U.S. Cl. CPC B60W 40/08; B60W 40/04; B60W 50/14; G06V 20/588; G06V 20/597; B60W 2520/14; B60W 2540/18; B60W 2540/225; B60W 2540/229; B60W 2552/53

(57) ABSTRACT

A vehicle safety system (37) includes at least one image sensor device (17), a control unit arrangement (5, 20, 22) and at least one warning device (11, 12). The image sensor device (17) is arranged to detect eye configurations of a vehicle driver (19). When the warning device (11, 12) is initiated to emit a first warning signal, the control unit arrangement (5, 20, 22) is arranged to determine if the vehicle driver (19) at least partly is looking outside a warning area (24, 25) that at least partly encompasses the warning device (11, 12), and in that case to issue a second warning signal.

### CROSS-REFERENCE TO RELATED APPLICATIONS

This application is a continuation of U.S. utility patent application Ser. No. 16/768,843, filed Jun. 1, 2020, which is a § 371 national phase of PCT Application No. PCT/EP2018/081534, filed Nov. 16, 2018, which claims the benefit of priority to European Patent Application No. 17204922.3, filed Dec. 1, 2017, the contents of which are incorporated herein by reference in their entirety.

### FIELD OF THE INVENTION

The present disclosure relates to a vehicle safety system including at least one image sensor device, a control unit arrangement and at least one warning device. The image sensor device is arranged to detect eye configurations of a vehicle driver.

### BACKGROUND

When changing lanes from a present lane to a target lane with an ego vehicle, it is desired to avoid collisions with vehicles traveling in the target lane. In particular, there is a risk of collision with vehicles traveling in the target lane which are in the so-called blind spot field, where these vehicles are more or less difficult to detect via the external rear-view mirror that is positioned at the side of the ego vehicle that faces the target lane, and also via the internal rear-view mirror.

It is previously known that the external rear-view mirror may be equipped with a warning light source that is adapted to emit a warning light when a vehicle is determined to be present in the blind spot field. Such a determining is for example enabled by use of a vehicle environment detecting system such as a vehicle radar system of the ego vehicle. This means that when a driver of the ego vehicle is about to change lanes and looks in the suitable external rear-view mirror and there is a vehicle in the blind spot field and thus is difficult to see, the driver is warned by the emitted light from the warning light source.

In order to enable the driver to be warned in this manner, it is important that the driver looks in the suitable external rear-view mirror when a lane-change is due. If the driver performs a lane-change without looking in the suitable external rear-view mirror, the driver will not notice the emitted light from the warning light source.

It is thus desired to obtain a blind spot field warning at lane change that is more robust and reliable than previously known equipment of this kind.

### SUMMARY OF EMBODIMENTS OF THE INVENTION

The present disclosure provides a method for a vehicle safety system. The method includes: detecting a hazard condition; initiating, in response to the hazard condition, a warning device to emit a first warning signal including a visual signal; determining a gaze direction of a vehicle driver; determining, based on the gaze direction, whether the vehicle driver is looking outside a warning area that encompasses the warning device; and issuing, after initiating the warning device to emit the first warning signal and in response to determining the vehicle driver looking outside the warning area, a second warning signal including at least one of a sound signal and a tactile signal.

The present disclosure also provides a vehicle safety system. The vehicle safety system includes: a warning device configured to emit a first warning signal including a visual signal; an image sensor device configured to detect an eye configuration of a vehicle driver; an image control unit in functional communication with the image sensor device and configured to detect a gaze direction of the vehicle driver; and a safety control unit in communication with the image control unit. The safety control unit is configured to: determine, in response to the warning device being initiated to emit the first warning signal, whether the vehicle driver is looking outside a warning area that encompasses the warning device; and issue, in response to determining the vehicle driver looking outside the warning area while the warning device emits the first warning signal, a second warning signal, wherein the second warning signal includes at least one of a sound signal and a tactile signal.

These and other aspects of the present disclosure are disclosed in the following detailed description of the embodiments, the appended claims, and the accompanying figures.

### BRIEF DESCRIPTION OF THE DRAWINGS

The present disclosure will now be described more in detail with reference to the appended drawings, where:

FIG. 1 shows a top view of an ego vehicle and a target vehicle in a dead spot field;

FIG. 2 shows a schematic partial cut-open side view of the ego vehicle with a driver;

FIG. 3 shows a schematic partial cut-open back view of the ego vehicle with a driver;

FIG. 4 shows a schematic overview of a vehicle safety system according to the present disclosure; and

FIG. 5 shows a flowchart for a method according to the present disclosure.

### DETAILED DESCRIPTION

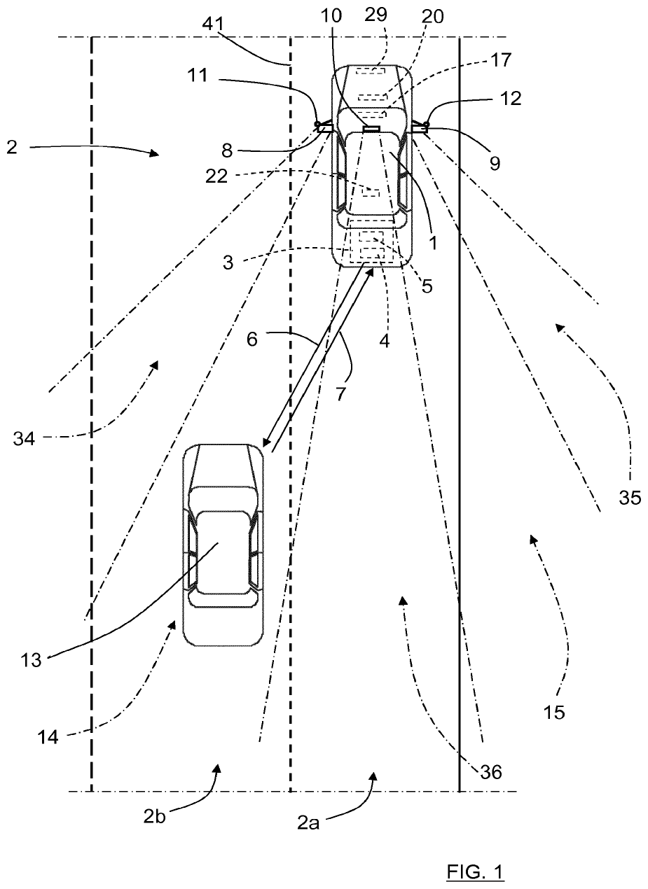

FIG. 1 schematically shows a top view of an ego vehicle 1 arranged to run in a first lane 2a on a road 2, where the ego vehicle 1 includes a vehicle radar system 3. The vehicle radar system 3 includes a radar sensor arrangement 4 that is arranged to distinguish and/or resolve targets from the surroundings by transmitting signal 6 and receiving corresponding reflected signals 7 and using a Doppler effect in a previously well-known manner. The signals 6, 7 are according to some aspects constituted by sweep signals in the form of FMCW (Frequency Modulated Continuous Wave) chirp signals 6 of a previously known kind.

The vehicle radar system 3 further includes a radar control unit 5 that is connected to the radar sensor arrangement 4 and is arranged to provide azimuth angles, distance and radial velocity of possible target object detections by simultaneously sampling and analyzing phase and amplitude of the received signals in a previously well-known manner.

The ego vehicle includes a left-hand external rear-view mirror 8, a right-hand external rear-view mirror 9 and an internal rear-view mirror 10. Each external rear-view mirror 8, 9 is equipped with a corresponding warning light source 11, 12 that is adapted to emit a warning light when a target vehicle 13 travelling in an adjacent second lane 2b, constituting a target lane 2b, is determined to at least partly be present in a left-hand blind spot field 14 or right-hand blind spot field 15, where a blind spot field 14, 15 is outside a coverage 34, 35 of the external rear-view mirrors 8, 9 and a coverage 36 of the internal rear-view mirror 10.

Such a determining is generally enabled by use of a vehicle environment detecting system, according to some aspects by use of the vehicle radar system 3 included in the ego vehicle 1. This means that when a driver of the ego vehicle is about to change lanes from the first lane 2a to the target lane 2b and looks in the left-hand external rear-view mirror 8, the radar system is adapted to determine if there is a target vehicle 13 in a blind spot field 14, 15. Here, a target vehicle 13 is determined to be in the left-hand blind spot field 14, and thus difficult to see.

A safety control unit 22 is then informed of this fact by radar control unit 5, where the safety control unit 22 then is adapted to warn the driver by initiating light emission from a left-hand warning light source 11 at the left-hand external rear-view mirror 8. It is, however, necessary that the driver looks at the left-hand external rear-view mirror 8 when being about to change lanes in order to discover the emitted light from the left-hand warning light source 11.

In general, detection of vehicle driver attentiveness is desirable since loss of, or in any way deteriorated, attentiveness impairs the ability of a vehicle to control the vehicle and to be aware of the surroundings.

A problem regarding deteriorated attentiveness is that, generally, persons do not detect their own lack of attentiveness when it appears. It is thus difficult for a person to be aware of lack of attentiveness, and to take action for counteraction. Deteriorated attentiveness may be due to different factors such as distracting objects or gadgets as well as drowsiness.

Today, many devices and methods for detecting attentiveness of a vehicle driver are known, and in most cases one or more digital cameras capture images of a vehicle driver's head features and the position of the eyes in order to calculate a gaze angle, and to determine where the gaze falls.

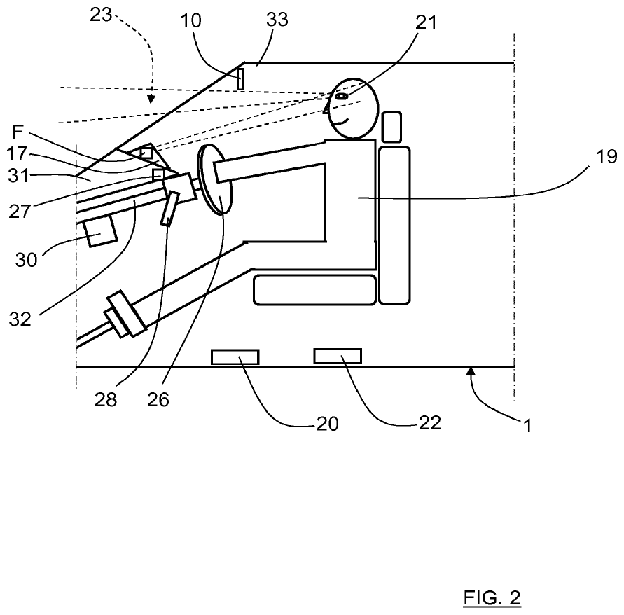

An example is shown in FIG. 2 that schematically shows a cut-open part of the ego vehicle 1, where the ego vehicle 1 includes a near infrared (NIR) internal digital camera device 17 positioned on a dashboard 31 with two NIR light sources F such as flashes, where the internal digital camera device 17 is part of in a driver monitoring system (DMS). The internal digital camera device 17 is arranged for capturing images of the eyes 21 of a person 19 driving the vehicle 1, a driver 19, and transferring these images to an image control unit 20. The image control unit 20 is adapted to process the acquired images and determine the position of the driver's eyes 21, and to determine where the gaze 23 of the eyes 21 falls.

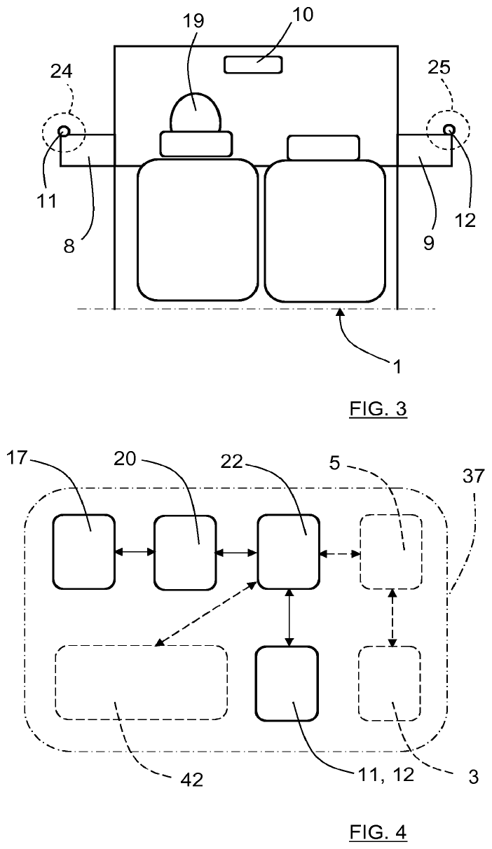

According to the present disclosure, also with reference to FIG. 3, schematically showing a partially cut-open back view of the driver 19 in the ego vehicle 1, the image control unit 20 is adapted to determine if the gaze 23 of the eyes 21 falls within a warning light window 24, 25, where each warning light window 24, 25 encompasses a warning light source 11, 12, when the warning light source 11, 12 has been initiated to emit a warning light that generally is constituted by a first warning signal.

In FIG. 3, a left-hand warning light window 24 is indicated for the left-hand warning light source 11, and a right-hand warning light window 25 is indicated for a right-hand warning light source 12 at the right-hand external rear-view mirror 9.

Generally, the safety control unit 22 is adapted to acquire information regarding:
if the driver 19 is about to change lanes,
if there at least partly is a target vehicle 13 within a blind spot field 14 that corresponds to the possible lane change, and
if the gaze 23 of the eyes 21 falls within a warning light window 24, 25 that corresponds to the possible lane change.

In the present example, there is a target vehicle 13 within a blind spot field 14, and if it also is determined that the driver 19 is about to change to a lane where the target vehicle 13 travels, and if it also is determined that the gaze 23 of the eyes 21 falls outside the left-hand warning light window 24, a second warning signal is issued to the driver. The second warning signal is according to some aspects constituted by a sound signal, a tactile signal such as an induced vibration at a steering wheel 26, a dashboard warning light signal 27, or any combination of these.

According to some aspects, in order to acquire information regarding if the driver 19 is about to change lanes, the safety control unit 22 is adapted to:
determine a signal indicator lever 28 setting,
determine change of steering angle, and/or
determining vehicle movement in relation to road markings 41.

For the above purposes, the ego vehicle 1 includes at least one of an external front-facing camera arrangement 29, and a yaw angle sensor arrangement 30, where the safety control unit 22 is adapted to acquire data regarding a signal indicator lever setting, and applicable sensor data. Generally, according to some aspects, there is a number of sensor devices 42 that provide sensor data to the safety control unit 22. Such sensor devices for example may include the yaw angle sensor arrangement 30, a sensor for the signal indicator lever setting, the external front-facing camera arrangement 29.

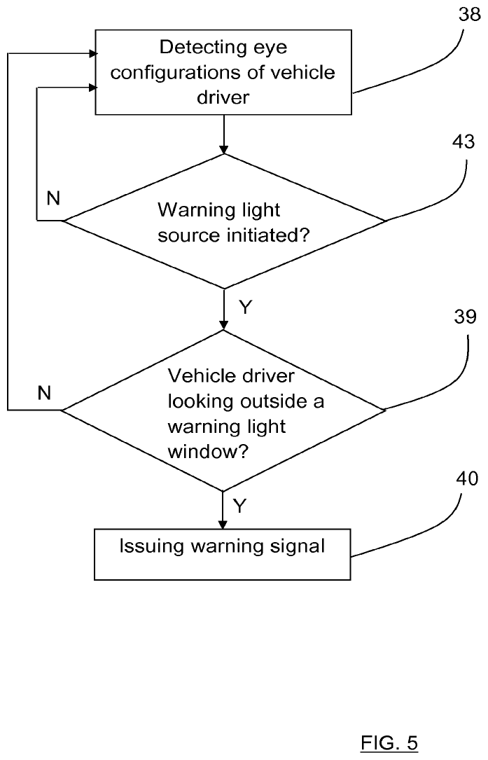

With reference to FIG. 5, the present disclosure also relates to a method for detecting attentiveness of a vehicle driver 19 with respect to at least one warning device 11, 12 that is initiated to emit a first warning signal, where the method includes the steps of:

Step 38: Detecting eye configurations of the vehicle driver 19.

Step 43: When the warning device 11, 12 is initiated to emit the first warning signal, the method further includes:

Step 39: Determining if the vehicle driver 19 at least partly is looking outside a warning area 24, 25 that at least partly encompasses the warning device 11, 12, and if that is the case:

Step 40: Issuing a second warning signal.

The present disclosure is not limited to the examples above, but may vary freely within the scope of the described embodiments. For example, there may be one or more NIR camera devices 17 and one or more NIR flashes F, where the image control unit 20 is arranged to send trigger signals to the internal digital camera device 17 and flashes F. The internal digital camera device 17 should be placed as close as possible to the line of sight of the driver 19 when the driver 19 is looking forward. However, the placement is more important in the horizontal direction than the vertical direction.

Other types of digital camera systems, with or without flashes, are conceivable. One advantage with an infrared camera is that it does not matter if the driver's eyes are obscured, for example by sunglasses. Other types of image sensors are also conceivable, where generally an image sensor device 17 is adapted to detect eye configurations of the vehicle driver 19.

Examples for camera positions are at the steering wheel 26, at a steering column 32, at the dashboard 31 or in the inner roof lining 33 as indicated in FIG. 1. Other examples are airbag covers, sun visors, the internal rear-view mirror 10, and/or in the vehicle A-pillars.

If the internal digital camera device 17 is positioned straight in front of the driver 19, it is less complicated to determine if the driver 19 is looking inside the predetermined field of view due to more available data. However, for practical reasons this may not be possible due to space limitations, design reasons and view obstructive reasons.

The control units 5, 20, 22 are according to some aspects included by one common or several separate units, and may also be included in another unit. The control units generally form a control unit arrangement 5, 20, 22.

According to some aspects, where the drivers gaze 23 falls is determined by using stored models of eye configuration samples that are indicative of eyes that look inside a predetermined field of view such as warning light window 24, 25. It is possible that stored models of eye configuration samples that are indicative of eyes that look outside a predetermined field of view, or both, are used instead.

Generally, the vehicle driver 19 is determined to be looking outside a warning light window 24, 25 when the gaze 23 falls outside that warning light window 24, 25 to a predetermined extent.

Generally, with reference to FIG. 4, the present disclosure relates to a vehicle safety system 37 including at least one internal digital camera device 17, a control unit arrangement 5, 20, 22 and at least one warning light source 11, 12 or other type of warning device. According to some aspects, the vehicle safety system 37 includes at least one environmental detection device 3 such as the radar system 3, a Lidar arrangement, an external camera device or similar, where the environmental detection device is adapted to detect if a target vehicle 13 at least partly is present within a blind spot field 14, 15 that is outside a coverage 34, 35, 36 of available rear-view mirrors 8, 9, 10 for the driver 19. The vehicle safety system 37 also includes sensor devices 42 that are adapted to provide sensor data to the control unit arrangement 5, 20, 22.

The coverages 34, 35, 36 mentioned above are related to the coverages 34, 35, 36 that are available for the driver 19. These coverages 34, 35, 36 of course change due to positioning of the rear-view mirrors 8, 9, 10, the physical properties of the driver 19 such as height as well as the driver's present head position. The blind spot fields 14, 15 are according to some aspects predetermined from a model that covers most of all normal cases. According to other aspects, the blind spot fields 14, 15 are determined adaptively by use of determined eye positions of the driver 19 relative the rear-view mirrors 8, 9, 10.

The present disclosure is not especially directed towards detecting whether a driver is noticing an activated warning light source 11, 12 associated with an external rear-view mirror 9, 10, but any type of activated warning light source or warning device. Generally, the present disclosure is directed towards detecting whether the driver 19 is noticing a first warning signal emitted from a warning device 11, 12. Generally, each warning light window 24, 25 is constituted by a corresponding warning area 24, 25.

The parts of the vehicle safety system 37, as well as other parts mentioned, normally include many more components that those mentioned, and it is to be understood that the present description is directed towards an understanding of the present disclosure. Components not shown or described are considered to be obvious for the skilled person, having well-known functionalities.

Generally, the present disclosure relates to a vehicle safety system 37 including at least one image sensor device 17, a control unit arrangement 5, 20, 22 and at least one warning device 11, 12, where the image sensor device 17 is arranged to detect eye configurations of a vehicle driver 19. When the warning device 11, 12 is initiated to emit a first warning signal, the control unit arrangement 5, 20, 22 is arranged to determine if the vehicle driver 19 at least partly is looking outside a warning area 24, 25 that at least partly encompasses the warning device 11, 12, and in that case to issue a second warning signal.

According to some aspects, the vehicle safety system 37 further includes at least one environmental detection device 3 that is adapted to determine whether a target vehicle 13 at least partly is within a blind spot field 14, 15 that is outside a coverage 34, 35, 36 of available rear-view mirrors 8, 9, 10 for the vehicle driver 19.

According to some aspects, the vehicle safety system 37 further is adapted to determine the following cases:
if the vehicle driver 19 is about to change lanes,
if there at least partly is a target vehicle 13 within a blind spot field 14, 15 that corresponds to the possible lane change,
if the vehicle driver 19 at least partly is looking outside a warning area 24, 25 that corresponds to the possible lane change, and
if all these cases are fulfilled, the vehicle safety system is adapted to issue the second warning signal.

According to some aspects, the vehicle safety system 37 is adapted to determine if the vehicle driver 19 is about to change lanes by being adapted to:
determine a signal indicator lever 28 setting,
determine change of steering angle by use of a yaw angle sensor arrangement 30, and/or
determine vehicle movement in relation to road markings by use of an external front-facing camera arrangement 29.

Generally, the present disclosure further relates to a method for detecting attentiveness of a vehicle driver 19 with respect to at least one warning device 11, 12 that is initiated to emit a first warning signal, where the method includes:

Step 38: detecting eye configurations of the vehicle driver 19. Furthermore,

Step 43: when the warning device 11, 12 is initiated to emit the first warning signal, the method further includes:

Step 39: determining if the vehicle driver 19 at least partly is looking outside a warning area 24, 25 that at least partly encompasses the warning device 11, 12, and if that is the case;

Step 40: issuing a second warning signal.

According to some aspects, the method further includes determining whether a target vehicle 13 at least partly is within a blind spot field 14, 15 that is outside a coverage 34, 35, 36 of available rear-view mirrors 8, 9, 10 for the vehicle driver 19.

According to some aspects, the method further includes determining the following cases: if the vehicle driver 19 is about to change lanes, if there at least partly is a target vehicle 13 within a blind spot field 14, 15 that corresponds to the possible lane change, if the vehicle driver 19 at least partly is looking outside a warning area 24, 25 that corresponds to the possible lane change, and if all these cases are fulfilled, the method further includes issuing the second warning signal.

According to some aspects, the method further includes determining if the vehicle driver 19 is about to change lanes by: determining a signal indicator lever 28 setting, determining change of steering angle by using a yaw angle sensor arrangement 30, and/or determining vehicle movement in relation to road markings by using an external front-facing camera arrangement 29.

The present disclosure provides a vehicle safety system including at least one image sensor device, a control unit arrangement, and at least one warning device. The image sensor device is arranged to detect eye configurations of a vehicle driver. When the warning device is initiated to emit a first warning signal, the control unit arrangement is arranged to determine if the vehicle driver at least partly is looking outside a warning area that at least partly encompasses the warning device, and in that case to issue a second warning signal.

The present disclosure also provides a method for detecting attentiveness of a vehicle driver with respect to at least one warning device that is initiated to emit a first warning signal. The method includes detecting eye configurations of the vehicle driver, and when the warning device is initiated to emit the first warning signal, the method further includes determining if the vehicle driver at least partly is looking outside a warning area that at least partly encompasses the warning device. If that is the case, a second warning signal is issued.

According to some aspects of embodiments of the present invention, the vehicle safety system further includes at least one environmental detection device that is adapted to determine whether a target vehicle at least partly is within a blind spot field that is outside a coverage of available rear-view mirrors for the vehicle driver.

According to some aspects of embodiments of the invention, the vehicle safety system further is adapted to determine the following cases: If the vehicle driver is about to change lanes. If there at least partly is a target vehicle within a blind spot field that corresponds to the possible lane change. If the vehicle driver at least partly is looking outside a warning area that corresponds to the possible lane change. If all these cases are fulfilled, the vehicle safety system is adapted to issue the second warning signal.

Other examples are disclosed in the following written disclosure and accompanying drawings figures.

A number of advantages are obtained by use of the present disclosure. Mainly, a much less complicated device and method for detection of vehicle driver attentiveness by determining where a driver is looking is provided, without the need for calculating such things as gaze angles, head angles and models for facial features.

While the above description constitutes an embodiment of the present invention, it will be appreciated that the invention is susceptible to modification, variation and change without departing from the proper scope and fair meaning of the accompanying claims.

What is claimed is:

1. A method for a vehicle safety system, said method comprising:
detecting a hazard condition;
initiating, in response to the hazard condition, a warning device to emit a first warning signal including a visual signal;
determining a gaze direction of a vehicle driver;
determining, based on the gaze direction, whether the vehicle driver is looking outside a warning area that encompasses the warning device; and
issuing, after initiating the warning device to emit the first warning signal and in response to determining the vehicle driver looking outside the warning area, a second warning signal including at least one of a sound signal and a tactile signal.

2. The method of claim 1, wherein detecting the hazard condition includes determining a target vehicle within a blind spot field that is outside a coverage of available rear-view mirrors for the vehicle driver.

3. The method of claim 1, wherein detecting the hazard condition includes:
determining if the vehicle driver is about to change lanes to a new lane; and
determining a target vehicle within a blind spot field that corresponds to the new lane.

4. The method of claim 3, further including determining an eye position of the vehicle driver; and
determining based on the eye position of the vehicle driver, each of the gaze direction and the blind spot field.

5. The method of claim 3, wherein determining if the vehicle driver is about to change lanes includes at least one of:
determining a turn signal indicator setting,
determining a change of steering angle, and
determining a vehicle movement in relation to road markings.

6. The method of claim 3, wherein determining the target vehicle within the blind spot field includes detecting the target vehicle using at least one of: a radar sensor arrangement, a Lidar arrangement, or an external camera device.

7. The method of claim 1, wherein the warning device is located on an external rear-view mirror.

8. The method of claim 1, wherein the warning device is not located on an external rear-view mirror.

9. The method of claim 1, wherein the second warning signal includes a vibration at a steering wheel.

10. The method of claim 1, wherein determining the gaze direction of the vehicle driver includes capturing, by an image sensor, one or more images of a head feature and an eye position of the vehicle driver.

11. A vehicle safety system comprising:
a warning device configured to emit a first warning signal including a visual signal;
an image sensor device configured to detect an eye configuration of a vehicle driver;
an image control unit in functional communication with the image sensor device and configured to detect a gaze direction of the vehicle driver; and
a safety control unit in communication with the image control unit, the safety control unit configured to:
determine, in response to the warning device being initiated to emit the first warning signal, whether the vehicle driver is looking outside a warning area that encompasses the warning device; and
issue, in response to determining the vehicle driver looking outside the warning area while the warning device emits the first warning signal, a second warning signal, wherein the second warning signal includes at least one of a sound signal and a tactile signal.

12. The vehicle safety system of claim 11, further comprising: an environmental detection device configured to determine whether a target vehicle is at least partly within a blind spot field that is outside a coverage of available rear-view mirrors for the vehicle driver, and
wherein the safety control unit is further configured to initiate the warning device to emit the first warning signal in response to determining the target vehicle being at least partly within the blind spot field.

13. The vehicle safety system of claim 12, wherein the environmental detection device includes at least one of: a radar sensor arrangement, a Lidar arrangement, or an external camera device.

14. The vehicle safety system of claim 11, wherein the safety control unit is further configured to detect a hazard condition and to initiate the warning device to emit the first warning signal in response to detecting the hazard condition, and
wherein detecting the hazard condition includes:
determining if the vehicle driver is about to change lanes to a new lane; and
determining a target vehicle within a blind spot field that corresponds to the new lane.

15. The vehicle safety system of claim 14, wherein determining if the vehicle driver is about to change lanes includes at least one of:
determining a turn signal indicator setting,
determining a change of steering angle, and
determining a vehicle movement in relation to road markings.

16. The vehicle safety system of claim 14, wherein the safety control unit is further configured to determine the blind spot field based on the eye configuration of the vehicle driver.

17. The vehicle safety system of claim 11, wherein the warning device is located on an external rear-view mirror.

18. The vehicle safety system of claim 11, wherein the warning device is not located on an external rear-view mirror.

19. The vehicle safety system of claim 11, wherein the second warning signal includes a vibration at a steering wheel.

20. The vehicle safety system of claim 11, wherein the second warning signal includes a dashboard warning light signal.
